(19) United States
(12) Patent Application Publication
(10) Pub. No.: US 2014/0250882 A1
(43) Pub. Date: Sep. 11, 2014

(54) HYDRAULIC BRAKE BOOSTER

(71) Applicant: Matthias KISTNER, Bretzfeld (DE)

(72) Inventor: Matthias KISTNER, Bretzfeld (DE)

(73) Assignee: Robert Bosch GmbH, Stuttgart (DE)

(21) Appl. No.: 14/200,985

(22) Filed: Mar. 7, 2014

(30) Foreign Application Priority Data
Mar. 11, 2013 (DE) 10 2013 204 127.6

(51) Int. Cl. B60T 13/14; B60T 13/68

(52) U.S. Cl. CPC B60T 13/148; B60T 13/686
USPC 60/545; 60/592

(57) ABSTRACT

A hydraulic brake booster includes: a piston housing; and a first piston and a second piston displaceably spaced apart from each other inside the piston housing in a longitudinal direction and sealed from an inner wall of the piston housing, the first piston being fixedly coupled to a pressure piston rod so that in an actuation the first piston exerts a fluid pressure on a first volume by way of one surface, and the second piston exerts the fluid pressure on a second volume by way of one surface. In the case of a failure of the brake booster, the first volume is connected with a variable volume situated between an annular surface of the first piston and an inner surface of the piston housing, so that when the pressure piston rod is actuated, a pressure equilibrium forms between the first volume and the variable volume.

### BACKGROUND OF THE INVENTION

1. Field of the Invention

The present invention relates to a hydraulic brake booster for use in a hydraulic brake system of a motor vehicle, especially a hydraulic brake booster having a backup function or a fallback system in the event of a system interruption.

2. Description of the Related Art

A conventional hydraulic brake booster, for example, is described in published German patent application document DE 10 2010 040 577 A1, which discloses a brake system; the brake system has a master brake cylinder provided with a first chamber, which is hydraulically connected to at least one wheel brake cylinder for decelerating a wheel of the vehicle; an actuation device for a mechanical action of the driver on a piston of the master brake cylinder in order to thereby pressurize hydraulic fluid in the first chamber of the master brake cylinder; and a pressure supply device, in hydraulic connection with the boost chamber (volume V3), which acts on the piston that is mechanically actuated by the driver when the wheel brake cylinder is actuated and which pressurizes the first chamber of the master brake cylinder.

The law requires that a fallback system or a backup function be provided in a failure or malfunction of the brake system, for instance as a result of a malfunction of the power supply to valves of the brake system, so that a deceleration effect of at least 2.44 m/s² at a force of 500 N is attained at the brake pedal.

FIG. 1 shows one specific development, illustrated in a simplified manner in a cross-sectional view, of a conventional hydraulic brake booster 10, made up of a piston housing 20, a first piston 30, a second piston 40, and a pressure piston rod 50, which extends through an opening 60 of piston housing 20 and is coupled to first piston 30. At its other end 51, pressure piston rod 50 is connected to a brake pedal (not shown here), which is operable by a driver of the motor vehicle and in this way transmits pressure in the direction of arrow 52 via surface 32 of first piston 30, which is permanently connected to pressure piston rod 50, to a first volume V1 filled with hydraulic fluid, or brake fluid.

First piston 30, second piston 40, and pressure piston rod 50 are each sealed from inner side 21 of piston housing 20 by seals 70, 71, 72, so that fluid situated inside the piston housing is unable to escape to the outside, or is unable to make its way from first volume V1 to second volume V2.

Via a first fluid line 80, volume V1 is in fluidic connection with a first brake circuit 90 (shown here only schematically), the first brake circuit 90, for example, being able to act on a front left wheel or wheel brake cylinder (not shown here) and a rear right wheel or wheel brake cylinder, in a manner known to one skilled in the art.

In an analogous manner, volume V2 is in fluidic connection with a second brake circuit 110 (likewise shown only schematically), via a second fluid line 100, the second brake circuit 110 then acting on the front right wheel or wheel brake cylinder (not shown here) and the rear left wheel or wheel brake cylinder. Naturally, other brake circuit systems or divisions are conceivable as well.

A fluid compressor or pressure reservoir 120 is in fluidic connection with piston housing 20 or its interior, via a third fluid line 130, which opens at location 140 on piston housing 20 in the direction of its interior, i.e., a (variable) volume that is situated between an annular surface 31 of first piston 30 and a corresponding inner surface 141, facing annular surface 31, of piston housing 20. As soon as the driver operates the brake pedal (not shown here), pressure piston rod 50 together with first piston 30 is shifted to the left in the figure, so that an enlarged volume forms between annular surface 31 and surface 141.

### BRIEF SUMMARY OF THE INVENTION

The present invention provides a hydraulic brake booster for use in a hydraulic brake system of a motor vehicle, in which the brake system acts on at least one wheel of the motor vehicle when actuated. The hydraulic brake booster includes a piston housing; at least one first piston and/or one second piston, which is/are set apart from each other inside the piston housing in a longitudinal direction of the piston housing, and which are able to be displaced within the piston housing and are sealed from an inner wall of the piston housing, the first piston being fixedly coupled to a pressure piston rod which is able to be actuated by the driver, so that in an actuation, the first piston exerts a fluid pressure on a first volume by way of one surface, and the second piston thus exerts the fluid pressure on a second volume by way of one surface, the fluid pressure being transmittable to brake circuits via fluid lines that are hydraulically connected to the volumes for decelerating the at least one wheel; and in a failure of the brake booster, the first volume is connected, via fluid lines that are hydraulically connected to the piston housing, with a variable volume that is situated between an annular surface of the first piston and an inner surface, lying opposite the annular surface, of the piston housing, so that when the driver actuates the pressure piston rod and the first piston coupled thereto, a pressure equilibrium forms between the first volume and the volume situated between the annular surface and the inner surface, so that in a failure and/or a malfunction of fluid pressure booster devices hydraulically connected to the piston housing, a relatively simple option is available to the driver for building up brake pressure in the brake system.

The advantage of the provided hydraulic brake booster results from the fact that in the event of a failure or a malfunction of fluid pressure booster devices that are hydraulically connected to the piston housing and are normally actuated electrically via the onboard electrical system of the motor vehicle, a better braking possibility is available than in the related art, i.e., one that requires a lower force expenditure by a driver, that is to say, a better fallback system or backup function of the brake system.

A valve is disposed in the fluid line, which is open in the currentless state for brake fluid that is flowing in a direction away from the first volume. Thus, it is advantageous that the aforementioned pressure equilibrium is possible at all times, i.e., even in a power failure of the onboard electrical system.

Moreover, it is preferred that the valve is actuable in an electric and/or hydraulic manner.

It is furthermore preferred that the fluid pressure booster devices are a fluid compressor and/or a pressure reservoir, which offers the advantage of an effective fluid pressure build-up.

Another advantage is that a relatively “normal” brake pedal feel is maintained for the driver when a malfunction occurs in the brake system and that the legal requirements with respect to the action of the brake system (deceleration of at least 2.44 m/s²) are exceeded at the same time.

### BRIEF DESCRIPTION OF THE DRAWINGS

FIG. 1 shows a cross-sectional side view of a conventional brake booster.

FIG. 2 shows a cross-sectional side view of a brake booster according to a specific embodiment of the present invention.

### DETAILED DESCRIPTION OF THE INVENTION

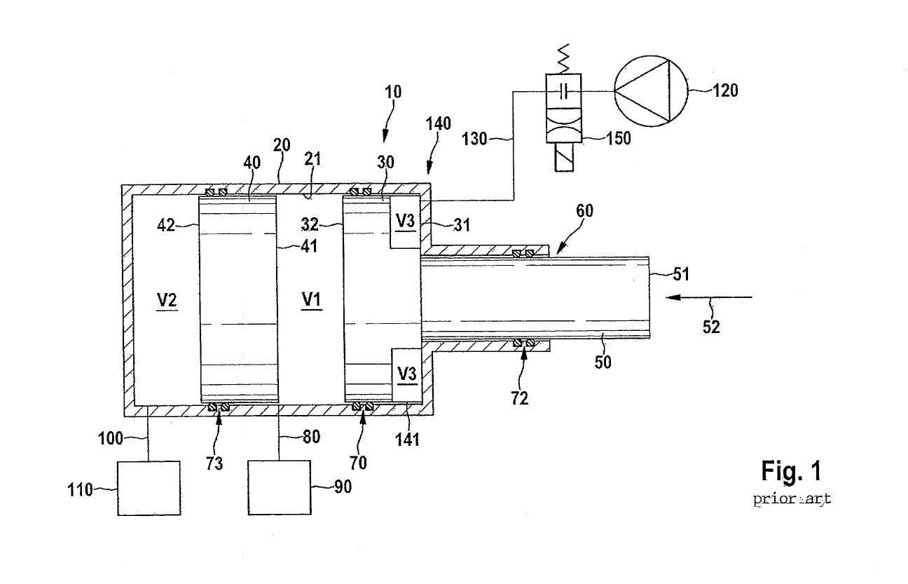

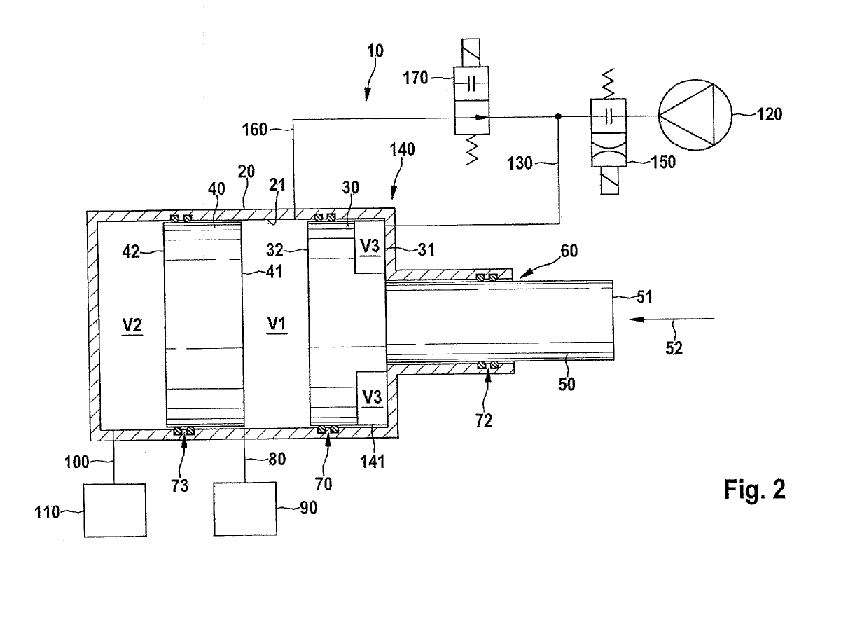

FIG. 2 shows a simplified cross-sectional side view of a brake booster according to one specific embodiment of the present invention. Like the illustration in FIG. 1, only the components that are essential for an understanding of the invention are shown, while the detailed illustration of additional components that are part of the overall brake system has been dispensed with. For example, the two brake circuits 90, 110 are shown only as “black boxes”, despite the fact that they actually include a multitude of components.

It should be noted at this point that, for the sake of simplicity, matching reference numerals in FIGS. 1 and 2 always refer to identical components.

The illustration shown in FIG. 2 is virtually identical with the illustration in FIG. 1 with the exception that brake booster 10 according to the present invention includes an additional fluid line 160 and an additional valve 170.

Since the general functionality of brake booster 10 has already been described earlier with reference to FIG. 1, the focus in the following text will be on additional components 160 and 170 in FIG. 2.

In a failure and/or a malfunction of the (in the currentless state, blocking) valve 150, such as a failure of the onboard electrical system or the power supply, fluid line 160 and fluid line 130 ensure that brake fluid from volume V1 reaches the area between annular surface 31 and inner surface 141 in order to support the driver or to make the braking operation easier for the driver. Valve 170 may be set up in such a way that it opens or is opened (electrically and/or hydraulically) above a predefined fluid pressure. In this way it is possible to increase the volume displaced into the brake system for the pressure buildup without any negative effect on the achievable deceleration.

Displacing brake fluid from V1 into the area between surface 31 and surface 141 then causes a pressure equilibrium to come about, i.e., pressure (V1) [p(V1)] corresponds to pressure (V3) [p(V3)] prevailing in boost chamber V3. In other words, despite a failure, no matter what its cause, of the valve control or the pressure buildup control, the driver is still able to generate brake pressure “manually”, so to speak, by operating the brake pedal, i.e., exerting a force 52 on surface 51 of pressure piston rod 50, the then acting pressure surface being surface 51 (surface 32 minus surface 31 equals surface 51). This pressure buildup is relatively simple, i.e., in comparison with the related art, that is to say, the driver has to exert less force, since the aforementioned pressure equilibrium comes about. This results in an improved fallback system.

It should also be noted that the illustrated dimensions need not necessarily be true to scale.

What is claimed is:

1. A hydraulic brake booster for a hydraulic brake system of a motor vehicle, the brake system acting on at least one wheel of the motor vehicle when actuated, the hydraulic brake booster comprising:
a piston housing; and
a first piston and a second piston which are (i) situated at a distance from each other inside the piston housing in a longitudinal direction of the piston housing, (ii) displaceable inside the piston housing, and (iii) sealed from an inner wall of the piston housing;
wherein the first piston is fixedly coupled to a pressure piston rod configured to be actuated by a driver, so that, when actuated, the first piston exerts a fluid pressure on a first volume by way of a first surface, and the second piston exerts the fluid pressure on a second volume by way of a second surface, the fluid pressure being transmitted, via fluid lines hydraulically connected to the first and second volumes, to brake circuits for decelerating the at least one wheel;
wherein the first volume is connected, via additional fluid lines hydraulically connected to the piston housing, to a variable volume situated between an annular surface of the first piston and an inner surface of the piston housing lying opposite from the annular surface, so that when the pressure piston rod and the first piston coupled to the pressure piston rod are actuated, a pressure equilibrium results between the first volume and the variable volume situated between the annular surface and the surface, such that in the case of a malfunction of at least one fluid-pressure booster device hydraulically connected to the piston housing, a driver of the vehicle is able to build up braking pressure in the brake system.

2. The hydraulic brake booster as recited in claim 1, wherein a valve is disposed in at least one of the additional fluid lines connecting the first volume to the piston housing, the valve being open in a currentless state for brake fluid flowing in a direction away from the first volume.

3. The hydraulic brake booster as recited in claim 2, wherein the valve is configured to be actuated at least one of electrically, mechanically and hydraulically.

4. The hydraulic brake booster as recited in claim 2, wherein the at least one fluid pressure booster device is at least one of a fluid compressor and a pressure reservoir.

5. The hydraulic brake booster as recited in claim 4, wherein the pressure piston rod is coupled to a brake pedal configured to be operated by a driver of the vehicle.
